(19) United States
(12) Patent Application Publication
(10) Pub. No.: US 2003/0122276 A1
(43) Pub. Date: Jul. 3, 2003

(54) Method for manufacturing a substrate strap for electrical elements

(76) Inventors: I-Chang Tsai, Yanchau Hsiang (TW); Jin-An Tsai, Yungkang City (TW)

Correspondence Address: DELLETT AND WALTERS, 310 S.W. FOURTH AVENUE, SUITE 1101, PORTLAND, OR, 97204, US

(21) Appl. No.: 10/318,546

(22) Filed: Dec. 13, 2002

(30) Foreign Application Priority Data
Dec. 28, 2001 (TW) 090132660

(51) Int. Cl. B29C 43/02

(52) U.S. Cl. 264/156; 264/160; 264/319

(57) ABSTRACT

A method for manufacturing a substrate strap for electrical elements has arts of preparing materials, mixing the materials with a mixer, pressing the mixed materials to a strap with a desired thickness, roller pressing the strap at a high temperature to a precious thickness, roller pressing the strap at a low temperature to set and defining holes in the strap with a punching machine. Accordingly, the molecules of the uncrystallized material can be connected between the crystals of the crystallized material so as to form multiple fibers in the strap, such that the substrate strap has an excellent structural strength.

### BACKGROUND OF THE INVENTION

1. Field of the Invention

The present invention relates to a method for manufacturing a substrate strap for electrical elements, and more particularly to a method for manufacturing a substrate strap with an excellent structural strength.

2. Description of Related Art

Electrical elements are attached to a substrate strap for automatic working processes. The substrate strap is a carrier for small electrical elements to convey the elements, and the electrical elements are taken from the substrate strap with a vacuum suction device. The conventional substrate strap has two types, one is made of paper, and the other is made of a single plastic material. The first conventional substrate strap is made of paper pulp and is composed of multiple layers of paper. However, the structural strength and the contractility of the first conventional substrate strap made of paper are easily influenced due to humidity or temperature of the environment, and the paper layers easily separate from each other. In addition, loosening of paper fibers occurs during the manufacturing process of the first conventional substrate strap and this pollutes the air. Furthermore, when the electrical elements are taken from the substrate strap, the loosened fibers easily occur on the paper conventional substrate strap to block the vacuum suction device.

The second conventional substrate strap is made of a plastic material and is punched with multiple holes for receiving the electrical elements. However, the resiliency of the plastic conventional substrate strap is not enough so that the conventional substrate strap easily breaks when the conventional substrate strap is reeled. In addition, rough edges easily occur on the inner surfaces of the holes in the second conventional substrate strap made of a plastic material and the electrical elements are prevented from being put into the holes. To enhance the structural strength of the plastic conventional substrate strap, glass fiber is added. However, the second conventional substrate strap with glass fiber is easily cracked during the punching process.

To overcome the shortcomings, the present invention tends to provide a method for manufacturing a substrate strap to mitigate or obviate the aforementioned problems.

### SUMMARY OF THE INVENTION

The main objective of the invention is to provide a method for manufacturing a substrate strap for electrical elements and that strap has excellent structural strength. The method has arts of preparing materials, mixing the materials with a mixer, pressing the mixed materials to form a strap with a desired thickness, roller pressing the strap at a high temperature to a precise thickness, roller pressing the strap at a low temperature to set, and defining holes in the strap with a punching machine. With the method, the molecules of the uncrystallized material can be connected between the crystals of the crystallized material, and the uncrystallized material is formed to multiple fibers connected and passing through the crystals of the crystallized material. Accordingly, the substrate strap has an excellent structural strength.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a method for manufacturing a substrate strap for electrical elements in accordance with the present invention;

FIG. 2 is a block diagram of an embodiment of a method for manufacturing a substrate strap for electrical elements in accordance with the present invention;

FIG. 3 is a perspective view of a substrate strap made with a method in accordance with the present invention; and

FIG. 4 is schematic drawing of crystals of the crystallized material with the fibers formed by the uncrystallized material in accordance with the present invention.

### DETAILED DESCRIPTION OF PREFERRED EMBODIMENT

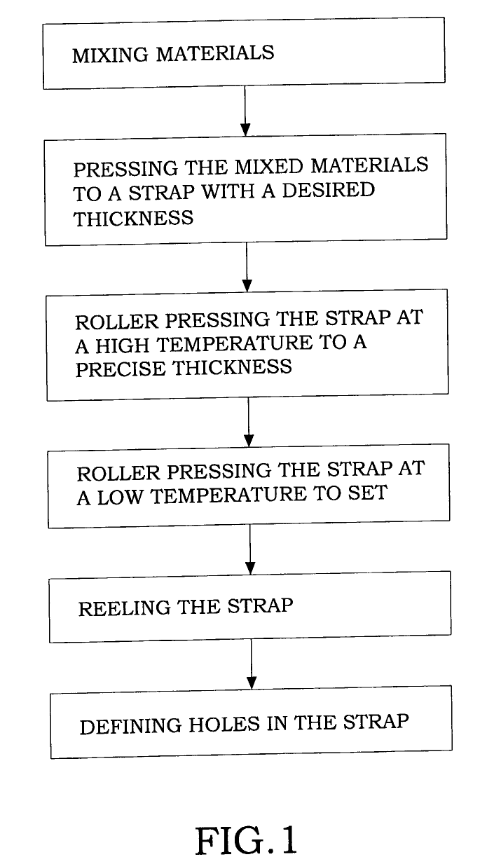

With reference to FIG. 1, a method for manufacturing a substrate strap for electrical elements in accordance with the present invention comprises acts of:

Preparing materials. The materials include crystallized material, uncrystallized material and a coupling agent. The crystallized material can be chosen from polyethylene (PE), polyamide (PA), polyoxymethylene (POM) and polytetrafluoroethylene (PTFE). The uncrystallized material can be chosen from polystyrene (PS), acrylonitrile-styrene copolymer (AS), acrylonitrile-butadiene-styrene terpolymer (ABS), polypropylene resin (PMMA), polyvinylchloride (PVC) and polycarbonate (PC).

Mixing the materials with a mixer.

Pressing the mixed materials to form a strap with a desired thickness by using a mold. The material is heated to 200 to 250° C. and is pressed to form a strap with a desired thickness with the mold. With the heating to the material, the mixed material are melted and mixed together.

Roller pressing the strap at a high temperature to a precise thickness. The strap is roller pressed at 40 to 80° C. to a precise thickness.

Roller pressing the strap at a low temperature to set. The strap is roller pressed at 5-20° C. to set at a final shape.

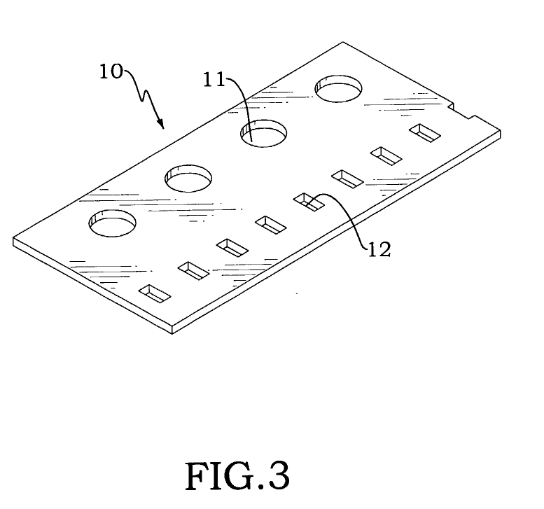

Defining holes in the strap with a punching machine. With reference to FIG. 3, multiple holes (12) are defined in the strap (10) for receiving the electrical elements, and multiple bores (11) are defined in the strap (10) for fitting with a conveyer to convey the substrate strap (10).

Before defining holes in the strap, the strap (10) is firstly reeled onto a reel for conveniently transporting the strap (10) from one place to another place. Consequently, the reeled strap (10) is released before punching holes in the strap and is then reeled again after being punched.

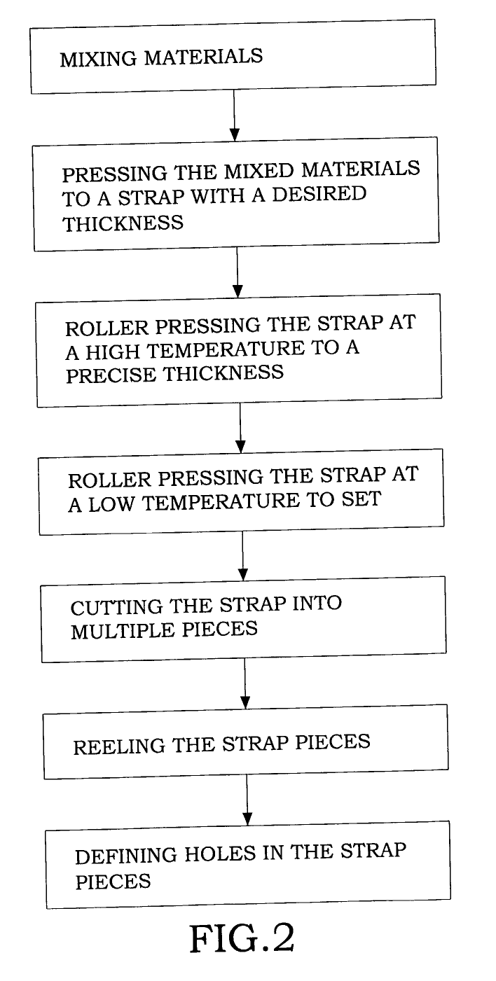

With reference to FIG. 2, before defining holes in the strap, the strap can be cut into multiple pieces with a desired length. Accordingly, the substrate strap has a length matching needs of users.

With the substrate strap manufactured by the method in accordance with the present invention, the substrate strap has the advantages as follows:

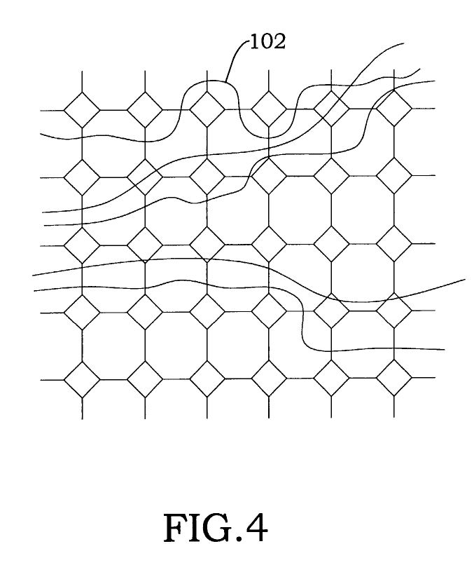

1. Excellent structural strength. With the mixing process, the molecules of the uncrystallized material will be connected between the crystals of the crystallized material. With reference to FIG. 4, the uncrystallized material is formed to fibers (102) connected and passing through the crystals of the crystallized material, such that the substrate strap has an excellent structural strength.

2. No contaminating fiber waste. No contaminating waste is produced during the manufacturing the substrate strap and thus the air is kept from being polluted.

3. No cut waste scraps. No waste scraps are produced when the electrical elements are removed from the holes in the strap. This can keep the vacuum suction device from being blocked.

4. Influence from the environment is lowered. The substrate strap made of crystallized material with uncrystallized material is not influenced by humidity or temperature of the environment, and the contractility of the substrate strap is lower than 0.2%.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing a substrate strap for electrical elements comprising following arts:
preparing materials; the materials include crystallized material, uncrystallized material and a coupling agent;
mixing the materials with a mixer;
pressing the mixed materials to a strap with a desired thickness by using a mold;
roller pressing the strap at a high temperature to a precise thickness;
roller pressing the strap at a low temperature to set; and
defining holes in the strap with a punching machine.

2. The method as claimed in claim 1, wherein the crystallized material is chosen from polyethylene (PE), polyamide (PA), polyoxymethylene (POM) and polytetrafluoroethylene (PTFE).

3. The method as claimed in claim 1, wherein the uncrystallized material is chosen from polystyrene (PS), acrylonitrile-styrene copolymer (AS), acrylonitrrle-butadiene-styrene terpolymer (ABS), polypropylene resin (PMMA), polyvinylchloride (PVC) and polycarbonate (PC).

4. The method as claimed in claim 1, wherein the material is heated to 200 to 250° C. and is pressed to form a strap with a desired thickness by using a mold.

5. The method as claimed in claim 1, wherein the strap is roller pressed at 40 to 80° C. to a precious thickness.

6. The method as claimed in claim 1, wherein the strap is roller pressed at 5-20° C. to set and to a final shape.

7. The method as claimed in claim 1 further comprising a step of reeling the strap onto a reel before defining holes in the strap.

8. The method as claimed in claim 1 further comprising a step of cutting the strap into multiple pieces with a desired length before defining holes in the strap.

9. The method as claimed in claim 8 further comprising a step of reeling the strap pieces onto a reel before defining holes in the strap.
